(19) United States
(12) Patent Application Publication
(10) Pub. No.: US 2007/0214840 A1
(43) Pub. Date: Sep. 20, 2007

(54) Apparatus and method for producing optical fiber preform and optical fiber produced therefrom

(76) Inventors: Sanket Shah, (US); Chandraveer Singh, (US); Nitin Shinde, (US)

Correspondence Address: JAMES RAY & ASSOCIATES, 2640 Pitcairn Road, Monroeville, PA, 15146, US

(21) Appl. No.: 11/593,780

(22) Filed: Nov. 7, 2006

(30) Foreign Application Priority Data
Mar. 14, 2006 (IN) 367/MUM/2006

(51) Int. Cl. C03B 37/023; C03B 37/018; B32B 17/06

(52) U.S. Cl. 65/385; 428/428; 65/421; 65/494

(57) ABSTRACT

An apparatus for producing an optical fiber preform, having no seeds or bubbles at the central axis thereof and having no points at the central axis thereof where breaks may be initiated while drawing optical fiber therefrom, comprising bottom holding means 8 capable: of holding bottom end 9 of soot porous body 1 having centerline 10 consisting of mandrel 2; top holding means 11 capable of holding handle rod 3 of soot porous body 1; at least one pulling means 12 capable of holding and pulling mandrel 2 fitted in centerline 10 of soot porous body 1; at least one additional pulling means 13 capable of holding and pulling mandrel 2 when it is partly pulled out of centerline 10 of soot porous body 1 is provided. A mandrel pulling mechanism is also provided.

### FIELD OF INVENTION

The present invention relates to apparatus and method for producing optical fiber preform and to optical fiber produced therefrom. Particularly, it relates to apparatus and method for producing optical fiber preform having no seeds or bubbles at the central axis of the preform and points at the central axis of the preform where breaks may be initiated while drawing optical fiber from such optical fiber preform. More particularly, it relates to apparatus and method for producing optical fiber preform which is capable of producing optical fiber having low attenuation loss preferably less than about 0.35 dB/Km at wavelength varying between about 1300 to about 1625 nm.

### BACKGROUND OF INVENTION

Optical fibers are inherently adaptable as a transmission medium for all forms of information be it voice or video or data.

The primary object of telecommunication industry is to transmit larger amounts of information over longer distances in shorter period of time. In the recent years, certain improvements have taken place in the light carrying ability of the optical fibers. However, light energy traveling through an optical fiber is inevitably subject to attenuation or loss due to numerous mechanisms. Some mechanisms, for example Rayleigh Scattering cannot be reduced below certain extent, while others, for example waveguide dispersion loss, impurity loss, moisture loss have been reduced to a certain extent in conventional single mode optical fiber.

The performance of any optical fiber for communication is primarily determined by the attenuation loss and the dispersion loss. If the attenuation loss is higher than the desired limit then the fiber cannot be employed for transmission in the entire wavelength region varying from about 1300 nm to about 1625 nm.

The optical fibers may be utilized for data transmission in the wavelength region varying between about 1300 nm to about 1625 nm. However, the use of conventional optical fiber is restricted to data transmission at about 1310 nm (O-band) and at about 1550 nm (C-band) wavelength regions. The major limitation of conventional optical fibers is that these cannot be used in the wavelength region varying between about 1360 to about 1460 nm (also known as E-band region). This limitation is observed due to high attenuation loss in this wavelength region, particularly at about 1383 nm during the transmission of information. This attenuation loss can be attributed to the presence of hydroxyl groups (or the OH ions) in the fiber. Therefore, in order to use the conventional single mode optical fiber in the E-band region, the hydroxyl ion related loss has to be eliminated. If it cannot be eliminated, then at least it should be reduced to have optical fiber suitable in E-band region.

In order to produce an optical fiber having low water absorption peak, the hollow soot porous body produced after removal of mandrel [hereinafter may also be referred to as target rod], is generally sintered and collapsed inside the sintering furnace to produce optical fiber preform. It has been observed that while removing mandrel from soot porous body to produce hollow soot porous body certain damages are produced in the centerline [hereinafter may also be referred to as capillary] of the hollow soot porous body.

The major drawback of above-said damages is that these result in formation of bubbles or seeds in the preform during the process of sintering and collapsing. Further, it is also observed that due to the damages caused during removal of mandrel from the soot porous body, certain points are formed in the preform during the process of collapsing where breaks may be initiated while drawing optical fiber from such optical fiber preform [such points, hereinafter may also be referred to as break points].

It has also been observed that once damages have occurred during removal of mandrel from a soot porous body to produce hollow soot porous body, the seeds or bubbles and/or break points will be formed in the preform produced from such hollow soot porous body thereby making the optical fiber useless for the desired purpose.

It is also observed that the amount of formation of seeds or bubbles and/or break points in the preform will depend upon the extent of damages caused in the centerline of the hollow soot porous body during the removal of mandrel from the soot porous body.

The major drawback of formation of seeds or bubbles in the preform during the collapsing process is that the optical fiber produced from such preform will have high attenuation loss, particularly in the E-band region thereby making the optical fiber unsuitable for the desired purpose.

The major drawback of formation of break points in the preform is that it results in breaking of the optical fiber while drawing from the optical fiber preform having such break points thereby resulting in poor productivity of the process.

The only way of overcoming above problems, once occurred, that is once above defined damages have occurred in the hollow soot porous body resulting in formation of seeds or bubbles and/or break points in the preform is to discard the respective portion of the preform thereby making the overall process for producing the optical fiber preform or for producing optical fiber less productive and highly uneconomical. Further, if above defined damages have occurred in the hollow soot porous body, that is, if seeds or bubbles have been formed and such portion of the preform is not discarded before drawing optical fiber therefrom, the optical fiber produced from such optical fiber preform will have high attenuation loss thereby making the optical fiber produced totally useless for the desired process, meaning thereby total economic loss.

Therefore, the optical fiber which can be safely employed in the wavelength region varying from about 1360 to about 1460 nm, particularly at the wavelength of about 1383 nm, that is the optical fiber which will have no OH ions or will have at least reduced OH ions, meaning thereby will have no or low water peak and will also have low attenuation loss in the wavelength region varying from about 1300 nm to about 1625 nm is the one which will have no seeds or bubbles in the preform from which it is produced.

Further, the optical fiber preform which can continuously produce the optical fiber without any breaks is the one which will have no break points where breaks may be initiated while drawing optical fiber from such optical fiber preform.

Therefore, for having an economical and productive process for producing optical fiber preform capable of producing optical fiber having low attenuation loss in the entire wavelength region varying from about 1300 nm to about 1625 nm, and having particular suitability for wavelength region varying from about 1360 to about 1460 nm, and having no or low water peak particularly at wavelength of about 1383 nm, and for having useful optical fiber capable of being safely employed in the entire wavelength region varying from about 1300 nm to about 1625 nm, including particularly the wavelength region varying from about 1360 to about 1460 nm, there is a need to have optical fiber preform free from seeds or bubbles and break points therein.

It may be noted that the terms “soot porous body”, “hollow soot porous body”, “centerline”, “optical fiber preform” and “optical fiber” have same meaning as known in the art. However, for further clarity, these terms are elaborated herein below in the description.

The U.S. Pat. No. 4,251,251 [herein after may also be referred to as patent '251] made an attempt to overcome above described problems of seeds or bubbles and break points formation in the preform, but only by discarding the respective portion of the preform thereby resulting in poor productivity and increase in cost of production. The patent '251 confirms occurrence of problems of damages while removal of mandrel from a soot porous body and of formation of seeds or bubbles in the preform produced from such soot porous body, but it neither teaches any method for either eliminating or reducing the damages occurring during removal of mandrel nor it teaches any method for either eliminating or reducing tendency to form seeds or bubbles during sintering and collapsing process to produce a preform.

The patent '251 also confirms problem of state of tension in the central region of the preform which presents a free surface in the region of high tensile force where breaks are readily initiated. However, it does not provide any solution to avoid formation of break points in the preform.

The patent '251 also confirms problem of formation of particle boundaries, that is of contamination of the centerline of the hollow soot porous body. The only solution proposed in this patent to avoid contamination is to subject the centerline of the hollow soot porous body to an acid wash followed by careful rinsing. The process steps of acid wash and careful rinsing to overcome problem of contamination, which are also dealt in description to follow, have their own drawbacks. The main drawback is addition of additional process steps which adds to duration of completion of process and to the cost to the process.

The method taught in the patent '251 relies on the principle of differential viscosity of core and clad layers. According to the method of this patent, the centerline in the hollow soot porous body will collapse if the ratio of viscosity of the core and viscosity of clad is equal to or less than ½. Therefore, the major limitation of the method of this patent is that it is not suitable for producing a preform where ratio of viscosity of the core and viscosity of clad is greater than ½. Another major limitation of the method of this patent is that it only anticipates that the centerline will collapse completely if said ratio of viscosity is maintained. However, this patent also confirms that under certain circumstances, it may be necessary to create a reduced pressure or to trap helium within the centerline of the hollow soot porous body to achieve complete closure of centerline.

However, it may be noted that the solution to achieve closure of centerline of hollow soot porous body does not overcome problems of occurrence of damages during withdrawal of mandrel which results in formation of seeds or bubbles and break points in the preform thereby makes the fiber produced useless, and makes the overall process highly non-productive and uneconomical.

Yet another major drawback of the method of the patent '251 is that its method just assumes that the preform is initially non-porous (incompressible) and the centerline tends to close as a result of selected ratio of viscosity of core and clad and/or applied pressure and/or surface tension acting on the centerline, meaning thereby this method is not suitable if the preform does not satisfy one or more of these assumptions, that is if the preform is porous in nature and/or the ratio of viscosities of core and clad is more than ½ and/or the desired surface tension is not acting on the centerline of the preform.

The U.S. Pat. No. 4,413,882 [herein after may also be referred to as patent '882] also made an attempt to overcome above described problems of seeds or bubbles and break points formation in the preform, but again either by discarding the respective portion of the preform thereby resulting in poor productivity and increase in cost of production or by suggesting formation of a thin stratum on the surface of mandrel before start of deposition of core and clad layers.

The main drawback of the method taught in the patent '882 is that it adds an additional process step thereby makes the overall process more time consuming and uneconomical.

The another main drawback of the method taught in the patent '882 is that even formation of thin stratum on the mandrel does not completely overcome above described problems of seeds or bubbles and break points formation in the preform.

Yet another limitation of the method taught in the patent '882 is that even this patent just assumes that the preform is initially non-porous (incompressible) and the centerline tends to close as a result of selected ratio of viscosity of core and clad and/or applied pressure and/or surface tension acting on the centerline, meaning thereby this method is also not suitable if the preform does not satisfy one or more of these assumptions, that is if the preform is porous in nature and/or the ratio of viscosities of core and clad is more than ½ and/or the desired surface tension is not acting on the centerline of the preform.

The another limitation of the method taught in the patent '882 is that the thin stratum has to be of a material of lower viscosity than that of the core material, meaning thereby this method is not suitable if the viscosity of thin stratum is greater than that of core material.

Further limitation of the method taught in the patent '882 is that the thickness of thin stratum should be between 0.3 to 0.6 mm or even more, meaning thereby this method is not suitable if the thickness of thin stratum is not as desired. It has been observed that if thickness of thin stratum is less than desired level, the problem of formation of seeds or bubbles and break points still continues.

To have satisfactory results, the method taught in the patent '882 proposes that thin stratum should comprise sufficiently large amounts of viscosity-depressing oxides such as P₂O₅, B₂O₃ or the like. The major problem of viscosity-depressing oxides is that these oxides cause change in the refractive index thereby making the fiber undesirable for certain applications. This problem can be overcome, but only partially and that's too by addition of dopant oxides thereby making the method more complicated, time consuming and expensive.

The major problem of employing sufficiently large amounts of viscosity-depressing oxides such as P₂O₅, B₂O₃ or the like in the thin stratum of the method taught in the patent '882 is that it may result in increase in attenuation loss thereby making the fiber produced totally unsuitable for application in the wavelength varying between about 1300 to about 1625 nm.

The U.S. Pat. No. 4,784,465 [herein after may also be referred to as patent '465] also made an attempt to overcome above described problems of seeds or bubbles and break points formation in the preform, but again either by discarding the respective portion of the preform thereby resulting in poor productivity and increase in cost of production or by suggesting additional process steps of etching, rinsing and drying the centerline before the steps of sintering and collapsing thereby once again making the method more complicated, highly time consuming and expensive.

The process steps of etching followed by rinsing and drying does not overcome problem of formation of seeds or bubbles and break points, but primarily these process steps overcome problem of contamination, which are also dealt in description to follow, have their own drawbacks. The main drawback of these process steps is addition of additional process steps which adds to duration of completion of process and to the cost to the process.

Another major limitation of the method taught in the patent '465 is that even this patent just assumes that the preform is initially non-porous (incompressible) and the centerline tends to close as a result of selected ratio of viscosity of core and clad and/or applied pressure and/or surface tension acting on the centerline, meaning thereby this method is also not suitable if the preform does not satisfy one or more of these assumptions, that is if the preform is porous in nature and/or the ratio of viscosities of core and clad is more than ½ and/or the desired surface tension is not acting on the centerline of the preform.

Yet another limitation of the method taught in the patent '465 is that even this method requires formation of thin stratum on the surface of mandrel before depositing core and clad layers thereby suffers from all respective drawbacks described hereinabove.

The another major drawback of all above described methods of the prior art is that these methods teach for removal of mandrel by mechanically twisting and pulling. It has been observed by the inventors of present invention that twisting on mandrel increases damages during removal of mandrel.

### NEED OF THE INVENTION

Accordingly, there is a need to provide apparatus and method for producing optical fiber preform which can overcome above described problems of damages to centerline of the hollow soot porous body which are caused during removal of mandrel from the soot porous body and problems of formation of seeds or bubbles and break points at the central axis of the preform so as to produce optical fiber preform having no seeds or bubbles at the central axis of the preform and having no points at the central axis of the preform where breaks may be initiated while drawing optical fiber from such optical fiber preform.

There is also a need to provide apparatus and method for producing optical fiber preform which is capable of producing optical fiber having low attenuation loss preferably less than about 0.35 dB/Km at wavelength varying between about 1300 to about 1625 nm.

### OBJECTS OF THE INVENTION

The main object of the present invention is to provide apparatus and method for producing optical fiber preform which can overcome above described problems of damages to centerline of the hollow soot porous body which are caused during removal of mandrel from the soot porous body and problems of formation of seeds or bubbles and break points at the central axis of the preform so as to produce optical fiber preform having no seeds or bubbles at the central axis of the preform and having no points at the central axis of the preform where breaks may be initiated while drawing optical fiber from such optical fiber preform.

The another main object of the present invention is to provide apparatus and method for producing optical fiber preform capable of producing optical fiber having low attenuation loss preferably less than about 0.35 dB/Km at wavelength varying between about 1300 to about 1625 nm thereby making the optical fiber suitable for the desired purposes.

Still another object of the present invention is to provide apparatus and method for producing optical fiber preform which is capable of producing optical fiber having low water absorption peak thereby making the optical fiber suitable for the desired purposes.

Yet another object of the present invention is to provide more useful, more productive and more economical apparatus and method for producing optical fiber preform which is capable of producing optical fiber having more wide applicability, particularly in the E-band region thereby making the optical fiber suitable for the desired purposes.

This is an object of the present invention to provide apparatus and method for producing optical fiber preform which is capable of continuously producing optical fiber without any breaks while drawing the same thereby making the overall process highly productivity.

This is another object of the present invention to provide apparatus and method for producing optical fiber preform which avoids need of discarding any portion of the preform thereby making the overall process highly productive and highly economical.

This is still an object of the present invention to provide apparatus and method for producing optical fiber preform which avoids state of tension in the central region of the preform thereby avoids free surface and hence, avoids initiation of breaks while drawing optical fiber from such optical fiber preform.

This is still another object of the present invention to provide apparatus and method for producing optical fiber preform which is also free from particle boundaries, that is from contamination, particularly at the centerline of the hollow soot porous body.

This is yet an object of the present invention to provide apparatus and method for producing optical fiber preform which does not require any process step involving acid wash followed by careful rinsing, or process steps of etching, rinsing and drying the centerline before the steps of sintering and collapsing thereby making the present method not only more safe and environment friendly, but also makes it less time consuming.

This is yet another object of the present invention to provide apparatus and method for producing optical fiber preform which neither relies on the principle of differential viscosity of core and clad layers, nor on the presumption that the preform is initially non-porous (incompressible) meaning thereby present method has wider applicability.

This is further an object of the present invention to provide apparatus and method for producing optical fiber preform which does not require formation of a thin stratum on the surface of mandrel before start of deposition of core and clad layers thereby making the process free from all associated limitations and drawbacks thereof including use of larger amounts of viscosity-depressing oxides such as P₂O₅, B₂O₃ or the like and making it less time consuming, more simple, more productive and more economical.

This is further another object of the present invention to provide apparatus and method for producing optical fiber preform wherein removal of mandrel can be safely performed without mechanical twisting thereby avoiding occurrence of damages in the centerline of hollow soot porous body.

### BRIEF DESCRIPTION OF THE INVENTION

The present invention relates to an apparatus for producing an optical fiber preform which comprises a mandrel pulling mechanism and to a method for producing an optical fiber preform employing a mandrel pulling mechanism of the present invention.

In accordance with present invention, the apparatus for producing an optical fiber preform having no seeds or bubbles at the central axis of the preform and having no break points at the central axis of the preform where breaks may be initiated while drawing optical fiber from such optical fiber preform comprises a mandrel pulling mechanism comprising a bottom holding means capable of holding bottom end of the soot porous body, a top holding means capable of holding handle rod of the soot porous body, at least one pulling means capable of holding and pulling the mandrel from the centerline of the soot porous body, at least one additional pulling means capable of holding and pulling the mandrel when it is partly pulled out of the centerline of the soot porous body.

Accordingly, the present invention relates to an apparatus for producing an optical fiber preform having no seeds or bubbles at the central axis thereof and having no points at the central axis thereof where breaks may be initiated while drawing optical fiber therefrom, wherein said apparatus comprises mandrel pulling mechanism comprising:—
a) a bottom holding means capable of holding bottom end of the soot porous body having a centerline consisting of mandrel;
b) a top holding means capable of holding handle rod of said soot porous body;
c) at least one pulling means capable of holding and pulling said mandrel fitted in said centerline of said soot porous body;
d) at least one additional pulling means capable of holding and pulling said mandrel when it is partly pulled out of said centerline of said soot porous body.

Accordingly, the present invention also relates to a mandrel pulling mechanism comprising:—
a) a bottom holding means capable of holding bottom end of the soot porous body having a centerline consisting of mandrel;
b) a top holding means capable of holding handle rod of said soot porous body;
c) at least one pulling means capable of holding and pulling said mandrel fitted in said centerline of said soot porous body;
d) at least one additional pulling means capable of holding and pulling said mandrel when it is partly pulled out of said centerline of said soot porous body.

Accordingly, the present invention also relates to a mandrel pulling mechanism comprising:—
a) a bottom holding means capable of holding bottom end of the soot porous body having a centerline consisting of mandrel;
b) a top holding means capable of holding handle rod of said soot porous body;
c) a pulling means comprising a holding means supported onto a pneumatic means.

Accordingly, the present invention also relates to a method for producing optical fiber preform having no seeds or bubbles at the central axis thereof and having no points at the central axis thereof where breaks may be initiated while drawing optical fiber therefrom, wherein said process comprises following process steps:—

i) depositing a thin layer of carbon soot on the surface of the mandrel;

ii) depositing soot over surface of carbon coated mandrel to form soot porous body;

iii) removing said mandrel from said soot porous body to form hollow soot porous body;

iv) dehydrating said hollow soot porous body in a controlled chemical environment suitable to remove the moisture in the core of hollow soot porous body;

v) simultaneously sintering and collapsing said dehydrated hollow soot porous body inside a sintering furnace to form solid glass optical fiber preform having no seeds or bubbles at the central axis thereof and having no points at the central axis thereof where breaks may be initiated while drawing optical fiber therefrom;
characterized in that said mandrel is removed by employing mandrel pulling mechanism safely and smoothly at a controlled speed without twisting and without disturbing alignment of its central axis with central axis of the preform.

Accordingly, the present invention also relates to optical fiber preform having no seeds or bubbles at the central axis thereof and having no points at the central axis thereof where breaks may be initiated while drawing optical fiber therefrom and to optical fiber produced therefrom.

The other objects, preferred embodiments and advantages of the present will be apparent from the following description when read in conjunction with the accompanying drawings which are incorporated for illustration of preferred embodiments and are not intended to limit scope of present invention.

### BRIEF DESCRIPTION OF THE ACCOMPANYING FIGURES

FIG. 1 shows a schematic representation of deposition process over a mandrel to produce a soot porous body.

FIG. 2 shows a schematic representation of hollow soot porous body having centerline therethrough after removal of mandrel from the soot porous body.

FIG. 3 shows a schematic cross-sectional view of hollow soot porous body having centerline therethrough after removal of mandrel from the soot porous body.

FIG. 4A shows a schematic representation of mandrel pulling mechanism when the mandrel is still in the soot porous body in accordance with one of the preferred embodiments of the present invention.

FIG. 4B shows a schematic representation of mandrel pulling mechanism when the mandrel has been safely and successfully removed from the soot porous body to produce a hollow soot porous body having a centerline therethrough in accordance with one of the preferred embodiments of the present invention.

FIG. 5 shows a schematic representation of mandrel pulling mechanism when the mandrel is still in the soot porous body in accordance with another preferred embodiment of the present invention.

### DETAILED DESCRIPTION OF THE INVENTION

Conventionally the process for producing optical fiber preform starts with the preparation of a cylindrical soot porous body [herein after referred to as soot porous body] by employing atmospheric chemical vapour deposition [ACVD] method [FIG. 1].

The soot porous body 1 can be prepared by any method known in the art. For example, by atmospheric chemical vapour deposition [ACVD] method. The preparation of soot porous body 1 comprises the following steps. The glass-forming precursor compounds are oxidized and hydrolyzed to form porous silica based materials. The porous silica based materials are deposited on a tapered cylindrical member referred as mandrel 2 provided a handle rod 3 and fitted on a lathe 4 to form soot porous body 1. During the deposition process, the mandrel 2 is rotated in a direction as illustrated by an arrow 5 and also moved along its length with reference to burner 6 to deposit the soot particles on the mandrel 2 for producing soot porous body 1. During the deposition process, the dopant chemicals for example GeCl₄ may also deposited to form the core of the preform and later the dopant chemicals may be terminated to form clad of the preform.

After completion of deposition, the soot porous body 1 is removed from lathe 4 along with mandrel 2 and handle rod 3.

It is apparently clear from the forgoing description that the optical fiber preforms produced by the apparatuses and/or methods known in the prior art suffer from various drawbacks, disadvantages and limitations as described herein.

It has been surprisingly observed by the inventors of the present invention that if mandrel can be safely and smoothly removed from the soot porous body at a controlled speed without twisting and without disturbing alignment of its central axis with central axis of the preform then the occurrence of damages in the centerline of hollow soot porous body to be produced thereafter can be avoided.

With above main object in mind, inventors of present invention surprisingly observed that a mandrel pulling mechanism capable of pulling mandrel safely and smoothly from a soot porous body at a controlled speed without twisting and without disturbing alignment of its central axis with central axis of the centerline of preform is a need of time for producing a hollow sot porous body having a centerline therethrough without any damages therein which on subjecting to process steps of consolidation and collapsing may produce an optical fiber preform having no seeds or bubbles at its central axis and having no points at its central axis where breaks may be initiated while drawing optical fiber from such optical fiber preform, which may produce optical fiber having low attenuation loss preferably less than about 0.35 dB/Km at wavelength varying between about 1300 to about 1625 nm.

The present invention, therefore, relates to an apparatus for producing an optical fiber preform which comprises a mandrel pulling mechanism and to a method for producing an optical fiber preform employing such a mandrel pulling mechanism.

In accordance with present invention the apparatus for producing an optical fiber preform having no seeds or bubbles at the central axis of the preform and having no break points at the central axis of the preform where breaks may be initiated while drawing optical fiber from such optical fiber preform comprises a mandrel pulling mechanism comprising a bottom holding means capable of holding bottom end [hereinafter may also be referred to as lower end] of the soot porous body, a top holding means capable of holding handle rod of the soot porous body, at least one pulling means capable of holding and pulling the mandrel from the centerline of the soot porous body, at least one additional pulling means capable of holding and pulling the mandrel when it is partly pulled out of the centerline of the soot porous body.

Accordingly, the present invention relates to an apparatus for producing an optical fiber preform having no seeds or bubbles at the central axis thereof and having no points at the central axis thereof where breaks may be initiated while drawing optical fiber therefrom, wherein said apparatus comprises mandrel pulling mechanism 7 comprising:—
a) a bottom holding means 8 capable of holding bottom end 9 of the soot porous body 1 having a centerline 10 consisting of mandrel 2;
b) a top holding means 11 capable of holding handle rod 3 of said soot porous body 1;
c) at least one pulling means 12 capable of holding and pulling said mandrel 2 fitted in said centerline 10 of said soot porous body 1;
d) at least one additional pulling means 13 capable of holding and pulling said mandrel 2 when it is partly pulled out of said centerline 10 of said soot porous body 1.

Accordingly, the present invention also relates to a mandrel pulling mechanism for an apparatus to produce an optical fiber preform having no seeds or bubbles at the central axis thereof and having no points at the central axis thereof where breaks may be initiated while drawing optical fiber therefrom, wherein said mechanism 7 comprises:—
a) a bottom holding means 8 capable of holding bottom end 9 of the soot porous body 1 having a centerline 10 consisting of mandrel 2;
b) a top holding means 11 capable of holding handle rod 3 of said soot porous body 1;
c) at least one pulling means 12 capable of holding and pulling said mandrel 2 fitted in said centerline 10 of said soot porous body 1;
d) at least one additional pulling means 13 capable of holding and pulling said mandrel 2 when it is partly pulled out of said centerline 10 of said soot porous body 1.

Accordingly, the present invention also relates to a mandrel pulling mechanism for an apparatus to produce an optical fiber preform having no seeds or bubbles at the central axis thereof and having no points at the central axis thereof where breaks may be initiated while drawing optical fiber therefrom, wherein said mechanism 7 comprises:—
a) a bottom holding means 8 capable of holding bottom end 9 of the soot porous body 1 having a centerline 10 consisting of mandrel 2;
b) a top holding means 11 capable of holding handle rod 3 of said soot porous body 1;
c) a pulling means 19 comprising a holding means 20 supported onto a pneumatic means 21.

In accordance with present invention said bottom holding means 8, said top holding means 11, said pulling means 12 and said additional pulling means 13 are supported on a substantially vertical support means 14.

The said pulling means 12 provided with a slot [not shown in figures] for holding said mandrel 2 is connected to a driving means 15 which is capable of rotating said pulling means 12 in clockwise direction at a controlled rotational speed so as to pull-out said mandrel 2 from said centerline 10 of said soot porous body 1 at a controlled speed without causing any twisting of said mandrel 2 and/or without causing any mechanical push of said mandrel 2 and/or without causing any mechanical stress of said mandrel 2 thereby avoiding formation of damages in said centerline 10 of said soot porous body 1.

Accordingly, in accordance with present invention, with controlled rotation of said pulling means 12 said mandrel 2 continues to pull out of said centerline 10 of said soot porous body 1 at a controlled speed without causing any twisting of said mandrel 2 and/or without causing any mechanical push of said mandrel 2 and/or without causing any mechanical stress of said mandrel 2 thereby avoiding formation of damages in said centerline 10 of said soot porous body 1. Once said mandrel 2 is pulled out preferably for about 1/10^{th} to ⅕^{th} of its length it is held by said additional pulling means 13.

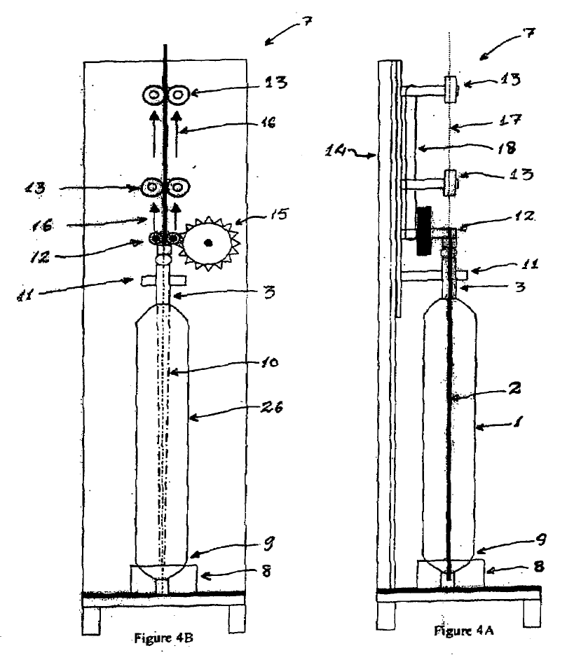

In accordance with one of the preferred embodiments of the present invention said additional pulling means 13 are freely rotatable and are capable of rotating in clockwise direction at a controlled rotational speed. The said mandrel 2 which is being continuously pulled out of said centerline 10 of said soot porous body 1 at a controlled speed by said pulling means 12 is held, after being pulled out preferably for about 1/10^{th} to ⅕^{th} of its length, in a slot [not shown in figures] provided for that purpose in said additional pulling means 13 and continuous to be pulled out, in upward direction as illustrated by arrow 16 [FIG. 4B], of said centerline 10 of said soot porous body 1 at a controlled speed by said pulling means 12 and said additional pulling means 13 without causing any twisting of said mandrel 2 and/or without causing any mechanical push of said mandrel 2 and/or without causing any mechanical stress of said mandrel 2 thereby avoiding formation of damages in said centerline 10 of said soot porous body 1.

In accordance with present invention said pulling means 12 and said additional pulling means 13 are concentric and are capable of holding and pulling said mandrel 2 along same central axis 17 as of said centerline 10 of said soot porous body 1 to produce hollow soot porous body 26.

In accordance with present invention said pulling means 12 and said additional pulling means 13 are capable of pulling said mandrel 2 at same controlled speed so that the pulling of mandrel is smooth and without any stress thereby avoiding occurrence of damages in said centerline 10 of said soot porous body 1.

In accordance with present invention said pulling means 12 and said additional pulling means 13 are capable of pulling said mandrel 2 at same controlled speed without causing any twisting of said mandrel 2 and/or without causing any mechanical push of said mandrel 2 and/or without causing any mechanical stress of said mandrel 2 thereby avoiding occurrence of damages in said centerline 10 of said soot porous body 1.

In accordance with one of the preferred embodiments of the present invention said pulling means 12 and said additional pulling means 13 are connected through a connecting means 18 for ensuring rotation of said additional pulling means 13 to rotate simultaneously and at same controlled rotational speed with said pulling means 12 which are capable of rotating with the help of said driving means 15.

In accordance with one of the preferred embodiments of the present invention said pulling means 12 are more than one, preferably two in number.

In accordance with another preferred embodiment of the present invention said additional pulling means 13 are more than one, preferably two in number.

The number of said pulling means 12 and said additional pulling means 13 depends upon length of said mandrel 2.

In accordance with preferred embodiment of the present invention said driving means 15 may be suitably supported on said support means 14 or alternatively may be supported on additional support means [not shown in figures].

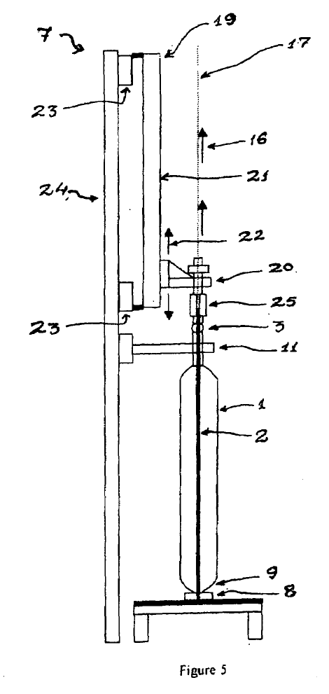

In accordance with another preferred embodiments of this invention the mandrel pulling mechanism 7 comprises a pulling means 19 comprising a holding means 20 supported onto a pneumatic means 21. The said holding means 20 is capable of moving up and down in vertical direction as illustrated by arrow 22 [FIG. 5] with the help of said pneumatic means 21 which is supported through supporting means 23 on a substantially vertical support means 24. The up movement of said holding means 20 is suitable for pulling said mandrel 2 out of said centerline 10 of said soot porous body 1 without causing any twisting of said mandrel 2 and/or without causing any mechanical push of said mandrel 2 and/or without causing any mechanical stress of said mandrel 2 thereby avoiding occurrence of damages in said centerline 10 of said soot porous body 1.

The bottom holding means 8 is capable of holding bottom end 9 of said soot porous body 1 having a centerline 10 consisting of mandrel 2 and a top holding means 11 is capable of holding handle rod 3 of said soot porous body 1.

The bottom holding means 8 is preferably provided with central hole for suitably holding said bottom end 9 of said soot porous body 1, and part of said mandrel 2, if it protrudes out of said soot porous body 1.

The top holding means 11 is preferably provided with central hole for suitably holding said handle rod 3 of said soot porous body 2.

In accordance with one of the preferred embodiments of the present invention, if mandrel 2 protrudes out of said handle rod 3, then it may be suitably held in mandrel holding means 25 provided with adjustable inner diameter to suitably accommodate said mandrel 2.

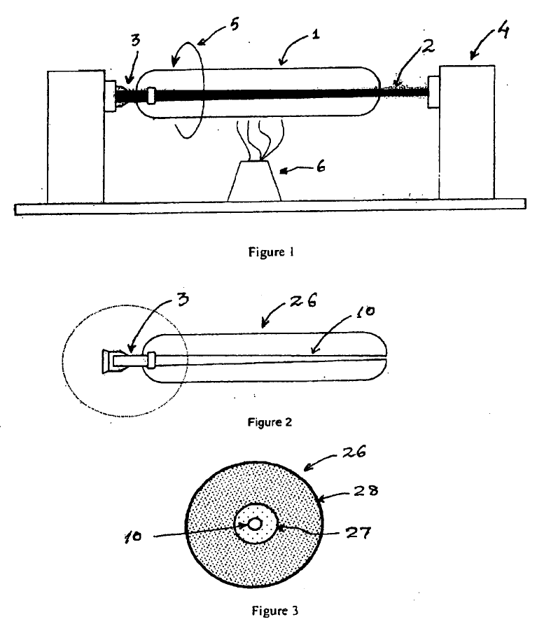

It may be noted that the soot porous body 1 after removal of said mandrel 2 from its said centerline 10 is referred as hollow soot porous body 26 [FIG. 2] which comprises a centerline 10, a core 27 and a clad 28 [FIG. 3].

After removal of mandrel 2, the hollow soot porous body 26 having a centerline 10 therethrough and along with handle rod 3 is examined, for example by using high power light placed at bottom end and passed through the centerline in order to view from the top end with the help of lenses for occurrence of damages in the centerline 10. It was observed that the centerline 10 of the hollow soot porous body 26 produced by employing mandrel pulling mechanism 7 of the present invention and method of employing the same did not show any evidence of damages in the centerline 10 zone.

Thereafter, the hollow soot porous body thus produced is transferred to the sintering furnace in order to achieve dehydration and sintering of the hollow soot porous body, and collapsing of the centerline during sintering therein to form a solid glass preform which is examined for formation of seeds or bubbles in the central axis thereof. It was observed that the central axis zone of the optical fiber preform produced by employing mandrel pulling mechanism of the present invention and method of employing the same did not show any evidence of formation of seeds or bubbles in the central axis zone of the preform.

The preform produced by employing mandrel pulling mechanism of the present invention and method of employing the same was thereafter, subjected to drawing of optical fiber. It was observed that the optical fiber was produced without even initiation of breaks till the optical fiber was drawn from the preform thereby confirming that no damages occurred while removing mandrel from centerline of soot porous body, and no seeds or bubbles and no break points were formed while simultaneously sintering and collapsing of centerline of hollow soot porous body to produce optical fiber preform having desired characteristics.

As described hereinabove, the preform may be produced by any known method, for example by employing ACVD method.

In one embodiment, the present invention provides a method of removing mandrel from the soot porous body to produce hollow soot porous body having no seeds or bubbles in the centerline zone.

Accordingly, the present invention also relates to a method for producing optical fiber preform having no seeds or bubbles at the central axis thereof and having no points at the central axis thereof where breaks may be initiated while drawing optical fiber therefrom, wherein said process comprises following process steps:—
i) depositing a thin layer of carbon soot on the surface of the mandrel;
ii) depositing soot over surface of carbon coated mandrel to form soot porous body;
iii) removing said mandrel from said soot porous body to form hollow soot porous body;
iv) dehydrating said hollow soot porous body in a controlled chemical environment suitable to remove the moisture in the core of hollow soot porous body;
v) simultaneously sintering and collapsing said dehydrated hollow soot porous body inside a sintering furnace to form solid glass optical fiber preform having no seeds or bubbles at the central axis thereof and having no points at the central axis thereof where breaks may be initiated while drawing optical fiber therefrom;
characterized in that said mandrel is removed safely and smoothly at a controlled speed without twisting and without disturbing alignment of its central axis with central axis of the preform by employing an apparatus for producing an optical fiber preform or employing a mandrel pulling mechanism of the present invention.

In accordance with present invention, the mandrel is pulled at a controlled speed. The controlled speed preferably varies in the range from about 10 mm/sec to about 40 mm/sec.

In another embodiments, the present invention provides optical fiber preform produced by employing mandrel pulling mechanism of the present invention, wherein the preform produced has no seeds or bubbles at the central axis thereof and has no points at the central axis thereof where breaks may be initiated while drawing optical fiber therefrom and optical fiber produced therefrom.

Accordingly, in one embodiment, the present invention also relates to optical fiber produced from the optical fiber preform having no seeds or bubbles at the central axis thereof and having no points at the central axis thereof where breaks may be initiated while drawing optical fiber therefrom, wherein said optical fiber has low attenuation loss preferably less than about 0.35 dB/Km at wavelength varying between about 1300 to about 1625 nm, and can be safely employed in entire wavelength region particularly in the wavelength region varying from about 1360 to about 1460 nm, more particularly at the wavelength of about 1383 nm, and has low OH ions, meaning thereby has low water peak and, hence has wider applicability.

It is clear from the forgoing description that the above described embodiments of the present invention have been surprisingly observed to avoid any twisting of said mandrel 2 and/or any mechanical push of said mandrel 2 and/or any mechanical stress of said mandrel 2 thereby have surprisingly ensured that no damages occur in said centerline 10 of said hollow soot porous body 26 while removal of said mandrel 2 from said centerline 10 of said soot porous body 1 to produce hollow soot porous body 26 which, thereafter, is subjected to process steps of simultaneous sintering and collapsing to produce desired optical fiber preform having no seeds or bubbles at the central axis of the preform and having no points at the central axis of the preform where breaks may be initiated while drawing optical fiber from such optical fiber preform.

Therefore, the apparatus for producing an optical fiber preform comprising mandrel pulling mechanism 7 of present invention overcomes above described problems of damages to centerline 10 of the hollow soot porous body 26 which are caused during removal of mandrel 2 from said soot porous body 1 thereby it also overcomes above described problems of formation of seeds or bubbles and break points at the central axis of the preform during the process steps of sintering and/or collapsing so as to produce optical fiber preform having no seeds or bubbles at the central axis of the preform and having no points at the central axis of the preform where breaks may be initiated while drawing optical fiber from such optical fiber preform.

The optical fiber preform produced by employing an apparatus comprising mandrel pulling mechanism of the present invention has also been surprisingly observed to be capable of producing optical fiber having low attenuation loss preferably less than about 0.35 dB/Km at wavelength varying between about 1300 to about 1625 nm.

Particularly, the optical fiber produced from the optical fiber preform produced by employing an apparatus comprising mandrel pulling mechanism of the present invention has been observed to be particularly suitable for application in the E-band region, that is observed to have almost negligible hydroxyl ion related loss.

Therefore, the optical fiber produced from the optical fiber preform produced by employing an apparatus comprising mandrel pulling mechanism of the present invention has been observed to be suitable for application in the wavelength region varying from about 1360 to about 1460 nm, particularly at the wavelength of about 1383 nm, that is has been observed to have low OH ions, meaning thereby has been observed to have low water peak and to have low attenuation loss in the wavelength region varying from about 1300 nm to about 1625 nm thereby making the present invention more useful, more productive and more economical.

Further, the method for producing optical fiber from optical fiber preform produced by employing mandrel pulling mechanism of the present invention has been observed to produce optical fiber without any breaks thereby making present method more useful, more productive and more economical.

The optical fiber referred herein is intended to include single mode optical fiber and multimode optical fiber.

The terms “varying between” and “varying from” have been employed with intention to include respective values.

The term “about” has been employed to include all possible practical errors in respective value.

The method of the present invention has been described for simultaneous sintering and collapsing steps for producing desired optical fiber preform. However, it may be noted that the hollow soot porous body produced by employing mandrel pulling mechanism and method of the present invention can also be subjected to a method wherein sintering and collapsing process steps may be performed one after another.

It may be noted that various modifications of the present invention are possible without deviating from the intended scope of this invention which are also intended to be included within the scope of the present invention. Although specific terms are employed herein, they are used in a generic and descriptive sense only and not for purpose of limitation.

1-22. (canceled)

23. An apparatus for producing an optical fiber preform having no seeds or bubbles at the central axis thereof and having no points at the central axis thereof where breaks may be initiated while drawing optical fiber therefrom, wherein said apparatus comprises mandrel pulling mechanism comprising:
a) a bottom holding means capable of holding bottom end of the soot porous body having a centerline consisting of mandrel;
b) a top holding means capable of holding handle rod of said soot porous body;
c) at least one pulling means capable of holding and pulling said mandrel fitted in said centerline of said soot porous body;
d) at least one additional pulling means capable of holding and pulling said mandrel when it is partly pulled out of said centerline of said soot porous body.

24. An apparatus of claim 23, wherein said bottom holding means, said top holding means, said pulling means and said additional pulling means are supported on a substantially vertical support means.

25. An apparatus of claim 23, wherein said pulling means is provided with a slot for holding said mandrel and is connected to a driving means which is capable of rotating said pulling means in clockwise direction at a controlled rotational speed so as to pull-out said mandrel from said centerline of said soot porous body at a controlled speed without causing any twisting of said mandrel and/or without causing any mechanical push of said mandrel and/or without causing any mechanical stress of said mandrel thereby avoiding formation of damages in said centerline of said soot porous body.

26. An apparatus of claim 23, wherein said additional pulling means are freely rotatable and are capable of rotating in clockwise direction at a controlled rotational speed.

27. An apparatus of claim 23, wherein said mandrel is held in a slot provided for that purpose in said additional pulling means.

28. An apparatus of claim 23, wherein said pulling means and said additional pulling means are concentric and are capable of holding and pulling said mandrel along same central axis as of said centerline of said soot porous body to produce hollow soot porous body.

29. An apparatus of claim 23, wherein said pulling means and said additional pulling means are capable of pulling said mandrel at same controlled speed so that the pulling of mandrel is smooth and without causing stress in or twisting of or mechanical push of said mandrel.

30. An apparatus of claim 23, wherein said pulling means and said additional pulling means are connected through a connecting means for ensuring rotation of said additional pulling means to rotate simultaneously and at same controlled rotational speed with said pulling means.

31. An apparatus of claim 23, wherein said pulling means are more than one, preferably two in number.

32. An apparatus of claim 23, wherein said additional pulling means are more than one, preferably two in number.

33. An apparatus of claim 26, wherein said driving means is suitably supported on said support means or alternatively supported on additional support means.

34. An apparatus of claim 23, wherein said bottom holding means is provided with central hole for suitably holding said bottom end of said soot porous body and part of said mandrel.

35. An apparatus of claim 23, wherein said top holding means is provided with central hole for suitably holding said handle rod of said soot porous body.

36. A mandrel pulling mechanism for an apparatus to produce an optical fiber preform, wherein said mechanism comprises:
a) a bottom holding means capable of holding bottom end of the soot porous body having a centerline consisting of mandrel;
b) a top holding means capable of holding handle rod of said soot porous body;
c) at least one pulling means capable of holding and pulling said mandrel fitted in said centerline of said soot porous body;
d) at least one additional pulling means capable of holding and pulling said mandrel when it is partly pulled out of said centerline of said soot porous body.

37. A mandrel pulling mechanism for an apparatus to produce an optical fiber preform, wherein said mechanism comprises:
a) a bottom holding means capable of holding bottom end of the soot porous body having a centerline consisting of mandrel;
b) a top holding means capable of holding handle rod of said soot porous body;
c) a pulling means comprising a holding means supported onto a pneumatic means.

38. A mandrel pulling mechanism of claim 27, wherein said holding means is capable of moving up and down in vertical direction with the help of said pneumatic means.

39. A mandrel pulling mechanism of claim 27, wherein said bottom holding means is provided with central hole for suitably holding said bottom end of said soot porous body and part of said mandrel.

40. A mandrel pulling mechanism of claim 27, wherein said top holding means is provided with central hole for suitably holding said handle rod of said soot porous body.

41. A method for producing optical fiber preform having no seeds or bubbles at the central axis thereof and having no points at the central axis thereof where breaks may be initiated while drawing optical fiber therefrom, wherein said process comprises following process steps:
i) depositing a thin layer of carbon soot on the surface of the mandrel;
ii) depositing soot over surface of carbon coated mandrel to form soot porous body;
iii) removing said mandrel from said soot porous body to form hollow soot porous body;
iv) dehydrating said hollow soot porous body in a controlled chemical environment suitable to remove the moisture in the core of hollow soot porous body;
v) simultaneously sintering and collapsing said dehydrated hollow soot porous body inside a sintering furnace to form solid glass optical fiber preform having no seeds or bubbles at the central axis thereof and having no points at the central axis thereof where breaks may be initiated while drawing optical fiber therefrom;
characterized in that said mandrel is removed safely and smoothly at a controlled speed without twisting and without disturbing alignment of its central axis with central axis of the preform by employing an apparatus for producing an optical fiber preform of claim 23.

42. A method of claim 41, wherein mandrel is pulled at a controlled speed preferably varying in a range from about 10 mm/sec to about 40 mm/sec.

43. Optical fiber preform having no seeds or bubbles at the central axis thereof and having no points at the central axis thereof where breaks may be initiated while drawing optical fiber therefrom which is produced by employing an apparatus for producing an optical fiber preform of claim 23.

44. Optical fiber produced from optical fiber preform of claim 43 having no seeds or bubbles at the central axis thereof and having no points at the central axis thereof where breaks may be initiated while drawing optical fiber therefrom.

45. A mandrel pulling mechanism of claim 36, wherein said bottom holding means is provided with central hole for suitably holding said bottom end of said soot porous body and part of said mandrel.

46. A mandrel pulling mechanism of claim 36, wherein said top holding means is provided with central hole for suitably holding said handle rod of said soot porous body.

47. Optical fiber preform having no seeds or bubbles at the central axis thereof and having no points at the central axis thereof where breaks may be initiated while drawing optical fiber therefrom which is produced by employing a mandrel pulling mechanism of claim 36.

48. Optical fiber preform having no seeds or bubbles at the central axis thereof and having no points at the central axis thereof where breaks may be initiated while drawing optical fiber therefrom which is produced by employing a mandrel pulling mechanism of claim 37.

49. A method for producing optical fiber preform having no seeds or bubbles at the central axis thereof and having no points at the central axis thereof where breaks may be initiated while drawing optical fiber therefrom, wherein said process comprises following process steps:
i) depositing a thin layer of carbon soot on the surface of the mandrel;
ii) depositing soot over surface of carbon coated mandrel to form soot porous body;
iii) removing said mandrel from said soot porous body to form hollow soot porous body;
iv) dehydrating said hollow soot porous body in a controlled chemical environment suitable to remove the moisture in the core of hollow soot porous body;
v) simultaneously sintering and collapsing said dehydrated hollow soot porous body inside a sintering furnace to form solid glass optical fiber preform having no seeds or bubbles at the central axis thereof and having no points at the central axis thereof where breaks may be initiated while drawing optical fiber therefrom;
characterized in that said mandrel is removed safely and smoothly at a controlled speed without twisting and without disturbing alignment of its central axis with central axis of the preform by employing a mandrel pulling mechanism of claim 36.

50. A method for producing optical fiber preform having no seeds or bubbles at the central axis thereof and having no points at the central axis thereof where breaks may be initiated while drawing optical fiber therefrom, wherein said process comprises following process steps:
i) depositing a thin layer of carbon soot on the surface of the mandrel;
ii) depositing soot over surface of carbon coated mandrel to form soot porous body;
iii) removing said mandrel from said soot porous body to form hollow soot porous body;
iv) dehydrating said hollow soot porous body in a controlled chemical environment suitable to remove the moisture in the core of hollow soot porous body;
v) simultaneously sintering and collapsing said dehydrated hollow soot porous body inside a sintering furnace to form solid glass optical fiber preform having no seeds or bubbles at the central axis thereof and having no points at the central axis thereof where breaks may be initiated while drawing optical fiber therefrom;
characterized in that said mandrel is removed safely and smoothly at a controlled speed without twisting and without disturbing alignment of its central axis with central axis of the preform by employing a mandrel pulling mechanism of claim 37.
